(19) United States
(12) Patent Application Publication
(10) Pub. No.: US 2026/0054444 A1
(43) Pub. Date: Feb. 26, 2026

(54) MANUFACTURING OF BLOW-MOLDED STRUCTURES FOR TEMPERATURE CONTROL MEDIA

(71) Applicant: TI Automotive Technology Center GmbH, Rastatt (DE)

(72) Inventors: Irfan KIZILAY, Reilingen (DE); Manuel LINDOW, Gernsbach (DE); Stefan LEIPOLD, Seltz (FR); Manuel ROEDER, Rastatt (DE)

(21) Appl. No.: 19/304,727

(22) Filed: Aug. 20, 2025

(30) Foreign Application Priority Data
Aug. 20, 2024 (DE) 102024123776.7

(51) Int. Cl. B29C 49/22; B29C 49/00; B29K 23/00; B29L 23/00

(52) U.S. Cl. CPC B29C 49/22; B29C 49/0005; B29C 49/071; B29C 2949/3042; B29K 2023/12; B29L 2023/22

(57) ABSTRACT

A method for producing blow-molded structures where a preform is provided that encloses a cavity and has a preform wall limiting the cavity. The preform is placed into a blow mold and formed to a blow-molded structure, wherein the blow-molded structure has a structural wall. The preform wall or structural wall comprises an inner layer and an outer layer.

### RELATED APPLICATIONS

The present disclosure claims priority to and the benefit of German Application 102024123776.7, filed on Aug. 20, 2024, the entire contents of each of which are incorporated herein by reference.

### FIELD

The present disclosure relates to methods for manufacturing blow-molded structures, and namely blow-molding a structural wall. The present disclosure also relates to a blow-molded structure produced by this method and to a use of the blow-molded structure.

### BACKGROUND

Blow-molded structures for guiding a temperature control medium are known from practice. In this case, a hollow, integral (without continuous boundary surfaces) preform is usually placed in a blow mold and then inflated by means of gas or air pressure until a blow-molded structure is formed on an inner side of the blow mold from the preform. Due to the versatility of the possible blow molds, the blow-molded structures can be used for a wide range of applications. An important application is the provision of blow-molded structures for guiding a temperature control medium, in particular a water-glycol solution. The blow-molded structures can be, for example, tanks, complex thermal management modules, or tubes with a cross-section that changes in the axial direction.

However, these blow-molded structures do not meet all functional requirements. For example, a blow-molded structure should be as impact-resistant and heat-resistant as possible.

### BRIEF SUMMARY

The present disclosure ensures that the blow-molded structure meets as many functional requirements as possible, particularly in the area of temperature control media guidance.

A method for manufacturing blow-molded structures includes providing a preform that encloses a cavity and has a preform wall defining the cavity, wherein the preform is introduced into a blow mold and formed to a blow-molded structure, wherein the blow-molded structure has a structural wall, and wherein the preform wall or the structural wall comprises an inner layer and an outer layer.

The present disclosure is based on the discovery that the blow-molded structures known to date in fact can meet all possible geometric requirements, especially in contrast to extruded structures. However, it was found that blow-molded structures often only partially meet the requirements in terms of mechanical or chemical properties. The present disclosure is further based on the realization that a combination of layers can serve several mechanical or chemical functions. As a result, the task mentioned at the beginning has been solved.

The term “preform wall” refers to a wall or the wall of the preform that at least partially encloses the cavity. If, for example, the preform is designed as a circular tube in cross-section, the preform wall completely encloses the cavity in cross-section, whereas at least one end face of the tube or preform may be open. It is conceivable, for example, that both end faces of the tube are open when inserted into the blow mold, whereby one of the two end faces of the tube is closed when the blow mold is closed due to the heat applied, and the gas or air is blown in through the other end face.

The term “structural wall” preferably refers to a wall of the blow-molded structure. It is preferred that the structural wall has at least one opening immediately after blow molding. It is possible that the number of openings is increased after blow molding. In principle, it is also conceivable that the at least one opening is closed in a subsequent process step immediately after blow molding.

The terms “preform wall” and “structure wall” preferably mean that their layers are connected to the respective adjacent layer or layers in a material-locking manner and/or preferably lie in surface contact against each other.

The term “one-piece” preferably means in the following that the one-piece body can only be divided into two or more pieces in a destructive manner, for example by cutting. An example of a one-piece body is a preform in the form of a tube with several coextruded and materially bonded layers, which is one-piece but not integral across the entire tube wall.

The term “integral” preferably refers to a body that has no internal, continuous boundary surfaces or interfaces. The term “internal continuous interfaces” preferably refers to internal interfaces that completely divide a body into at least two areas that have no connection beyond the interfaces. For example, the interfaces of the layers of a coextruded tube are continuous internal interfaces. For the production of an integral body, it is expedient that the body is produced from a single melt is a necessary but not sufficient condition. It is expediently further necessary that the body produced from a melt is not supplemented by further bodies from this melt, which would in turn create internal interfaces on the overall body, so that the overall body would not be integrally formed.

Consequently, a multilayer, coextruded tube or a multilayer preform is integrally formed in layers and is also formed in one piece across the entire tube wall or preform wall, but not integrally across the entire tube wall or preform wall. A layer of a multilayer tube is integrally formed along the tube and, in particular, completely integrally formed. The reason for this is that each of the layers is assigned to its own melt. The different layers are conveniently recognizable microscopically or by other imaging techniques, in particular at the interfaces between the layers. The term “integral” preferably encompasses bodies formed “integrally in layers” and bodies formed “completely integrally.”

The outer layer conveniently surrounds the inner layer. It is possible that the outer layer is adjacent to the inner layer. It is possible that a further layer, for example an adhesive layer, is arranged between the inner layer and the outer layer. It is highly preferred that the inner layer is the innermost layer of the preform wall or the structural wall. Conveniently, the inner layer or innermost layer is arranged so that it comes into contact with a fluid or temperature control medium. The outer layer can be the outermost layer.

According to a preferred embodiment, the structural wall is formed from the preform wall, wherein preferably the inner layer of the structural wall is formed from the inner layer of the preform wall and/or the outer layer of the structural wall is formed from the outer layer of the preform wall. This causes the layers to be subjected to blow molding and not to be added after blow molding. This results in more efficient production. Preferably, the exterior layer of the structural wall is formed from the exterior layer of the preform wall. Advantageously, the adhesive layer of the structural wall is formed from the adhesive layer of the preform wall. It is preferred that the adhesion layer of the structural wall is formed from the adhesion layer of the preform wall.

The inner layer of the preform wall or the structural wall very preferably comprises a polyolefin and, in particular, a polypropylene. The polyolefin causes the inner layer to be well suited as a barrier for liquid fluids, in particular for water-and/or oil-containing temperature control media, for example for water-glycol solutions or a dielectric oil-containing temperature control medium. The polypropylene causes the inner layer to be thermally stable and, in particular, to tolerate a heated temperature control medium well and, in particular, better than, for example, polyethylene. Preferably, the weight proportion of the polyolefin or polypropylene is at least 30 or 50 or 70 or 90% of the inner layer.

According to a highly preferred embodiment, the preform wall or structural wall comprises at least 30, 40, 50, or 70% by weight of a polyolefin, in particular polypropylene. It is advantageous that at least two of the layers, and preferably all of the layers, of the preform wall or structural wall comprise a polyolefin or polypropylene. This results in a blow-molded structure that is particularly well suited for temperature control media, whose layers are characterized by good adhesion to one another. The good adhesion ensures that even after blow molding, there is a reliable flat bond between the layers.

Preferably, the preform wall or structure wall comprises only two layers, or only the inner layer and the outer layer. It is advantageous for the polyolefin or polypropylene of the inner layer of a two-layer preform wall or structure wall to comprise a polyolefin or polypropylene regenerate. Preferably, the weight proportion of the polyolefin or polypropylene regenerate is at least 30, 50, 70, or 90% of the inner layer. It is preferred that the outer layer of the two-layer preform wall or structural wall comprises a polyolefin, in particular a polyethylene, a polypropylene, an olefin-based thermoplastic elastomer and/or an olefin-containing thermoplastic vulcanizate. This results in good adhesion to the inner layer, so that an intermediate bonding layer can be dispensed with and a compact layer structure is achieved.

It is advantageous for the blow-molded structure or preform to have an exterior layer, the exterior layer preferably enclosing the outer layer. This protects the outer layer and allows the tube to perform a wider range of functions. The exterior layer can be the outermost layer. The exterior layer advantageously comprises a polyolefin, in particular a polyethylene or a polypropylene, especially a polypropylene modified to be impact-resistant. The polyolefin of the exterior layer ensures good adhesion to the outer olefin-containing layer. The polyethylene or polypropylene ensures that the blow-molded structure has relatively good impact strength even at low temperatures. It is possible for the exterior layer to lie against the outer layer. An additional layer, for example an adhesion layer, may be located between the exterior layer and the outer layer. The weight proportion of the polyolefin or polyethylene or polypropylene of the exterior layer is preferably at least 30 or 50 or 70 or 90%.

The exterior layer may comprise a polyamide, in particular an aliphatic polyamide and preferably PA11 or PA12. The exterior layer comprising a polyamide preferably encloses an outer layer which preferably comprises an adhesion promoter. In the case of an exterior layer comprising a polyamide, the inner layer preferably comprises a polyolefin or polypropylene regenerate. The proportion of the regenerate is preferably at least 30, 50, 70, or 90 wt. %.

It is preferred that the exterior layer or the outer layer or the outermost layer of the preform wall or the structural wall comprises a thermoplastic elastomer. The thermoplastic elastomer preferably comprises an olefin. Advantageously, the outer layer comprises an olefin-based thermoplastic elastomer and/or an olefin-containing thermoplastic vulcanizate. The thermoplastic elastomer increases the flexibility of the tube so that the tube can compensate for volume changes in the fluid or temperature control medium, for example. Water in particular tends to undergo significant volume changes, which can be absorbed by appropriately flexible layers. The outer layer thus protects the inner layer from cracks. An advantage of thermoplastic elastomers comprising an olefin is that they adhere well to the polyolefin of the inner layer. This effectively prevents delamination in particular. The olefin-containing thermoplastic vulcanizate preferably comprises a mixture of polypropylene and ethylene-propylene-diene rubber (EPDM) and is preferably marketed under the name “Santoprene.” The weight proportion of the thermoplastic elastomer in the outer layer is preferably at least 30%, 50%, 70% or 90%.

In the case of an exterior layer comprising an olefin, it is advantageous for the outer layer to comprise a polyolefin, polypropylene, polyolefin regenerate or polypropylene regenerate. The weight proportion of the polyolefin or polypropylene or polyolefin regenerate or polypropylene regenerate in the outer layer is preferably at least 30 or 50 or 70 or 90%. In the case of an exterior layer comprising an olefin, it is advantageous for the inner layer to comprise a virgin polyolefin or polypropylene, preferably at least 30, 50, 70, or 90% by weight, respectively. This allows well-defined properties to be provided for the inner layer.

The blow-molded structure or preform may comprise an adhesive layer and/or an adhesion layer. This results in better adhesion of the layers to each other, which counteracts the risk of delamination during blow molding. Due to the very strong expansion of the preform wall in some places, the risk is relatively high in these areas of large expansion, although this can be counteracted by means of an adhesive layer or adhesion layer. The adhesive layer is preferably located between the inner layer and the outer layer. It is advantageous for the adhesion layer to be located between the outer layer and the exterior layer. It is highly preferred that the adhesive layer and/or the adhesion layer comprise a polyolefin. Advantageously, the weight proportion of the polyolefin in the adhesive layer or the adhesion layer is at least 50%, 70%, or 90%, respectively. It is very advantageous if the adhesive layer or the adhesion layer contains an additive to increase the bonding or adhesion. The additive for increasing the adhesion is preferably maleic anhydride. The proportion of the additive for increasing the adhesion in the adhesive layer or adhesion layer is preferably at least 0.5 or 1% by weight. It is preferred that the proportion of the additive for increasing the bonding/adhesion is at most 10%, 7% or 5% by weight of the adhesive layer or adhesion layer.

It is highly preferred that the preform is a tube and, in particular, an extruded or coextruded tube. This allows efficient, continuous production of the preforms. In particular, the coextruded tube can be cut regularly by a separating device during the process, so that a large number of preforms can be produced in a short time. It is preferred that the coextruded tube has a round, and in particular circular, cross-section.

It is possible for the blow-molded structure to comprise at least three outlets. This allows blow molding to demonstrate its advantage over extrusion, as blow molding enables more complex geometries. It is preferable for the blow-molded structure to comprise at least three openings, wherein the openings can be created during blow molding and/or after blow molding by one or more separation steps. Conveniently, the outlets of the blow-molded structure branch off from a main volume of the blow-molded structure. It is possible that each of the outlets has an opening.

It is preferred that the blow-molded structure has a wall thickness of at least 0.2, 0.3, or 0.4 mm, respectively. Advantageously, the wall thickness of the blow-molded structure is at most 8.0, 6.0, 5.0, or 4.0 mm.

The preform or the blow-molded structure may comprise an intermediate layer, wherein the intermediate layer preferably encloses at least the inner layer. The intermediate layer may comprise a plastic and preferably a plastic foam. This insulates the temperature control medium so that the ambient temperature does not unduly influence the temperature control medium on its way to a component to be temperature controlled. Advantageously, the intermediate layer is enclosed by the outer layer and/or the exterior layer.

The task mentioned at the beginning is solved by a blow-molded structure, wherein the blow-molded structure is produced according to at least one of the above aspects of the method according to the present disclosure. This causes the blow-molded structure to benefit from the blow-molding manufacturing process. The advantage of blow molding lies in particular in the possibility of giving the blow-molded structure particularly complex geometries. The blow molding manufacturing process is recognizable in the blow-molded structure. On the one hand, there are regular mold burrs that form on the blow-molded structure where two mold halves of the blow mold tool come into contact with each other or where a mold tool has an edge. On the other hand, the geometry of blow-molded structures alone makes it clear that only blow molding can produce such a structure. This is the case, for example, with all blow-molded structures with a larger cavity, as production by injection molding would simply be too complex. In addition, the wall thicknesses of blow-molded structures vary much more than in the case of extruded or injection-molded structures. With the aid of microscopic examination, it is always possible for an expert to determine whether a structure has been extruded, injection molded, or blow molded. It is preferable that the inner layer and/or the outer layer and/or the exterior layer and/or the adhesive layer and/or the adhesion layer are integrally formed.

The task mentioned at the beginning is solved by the use a blow-molded structure manufactured according to at least one of the aspects of the present disclosure for guiding a temperature control medium, wherein the temperature control medium preferably comprises water or an oil. This causes the inner layer to come into contact with a temperature control medium. It is particularly advantageous if the inner layer comprises a polyolefin. This is because polyolefins are chemically resistant to practically all temperature control media, and in particular to oil-based or water-based temperature control media. In addition, temperature control media can become quite warm, which, however, some polyolefins and in particular some polypropylenes tolerate well.

### BRIEF DESCRIPTION OF THE DRAWINGS

The present disclosure is explained in more detail below with reference to three embodiments and three figures.

FIG. 1 shows a cross-section of a preform according to the present disclosure in a first embodiment,

FIG. 2 shows a cross-section of a preform according to the present disclosure in a second embodiment, and

FIG. 3 shows a cross-section of a preform according to the present disclosure in a third embodiment.

### DETAILED DESCRIPTION

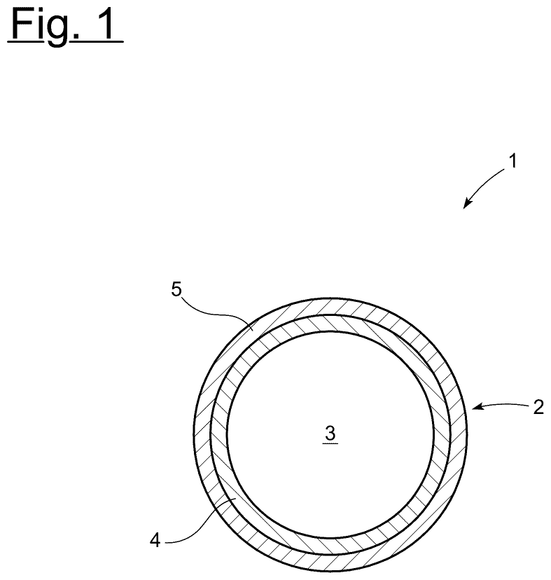

FIG. 1 shows a first embodiment of a preform 1 according to the present disclosure in the form of a tube with a constant cross-section. The preform 1 or the tube of the first embodiment comprises a preform wall 2 which encloses a cavity 3. The preform wall 2 is preferably ring-shaped in cross-section and, in particular, circular ring-shaped.

The preform 1 or the tube or the preform wall 2 of the first embodiment comprises an inner layer 4 and an outer layer 5. Preferably, the outer layer 5 encloses the inner layer 4. In this embodiment, the outer layer 5 is adjacent to the inner layer 4. It is possible that the outer layer 5 is also the outermost layer of the preform wall 2 or the preform 1. In this embodiment, the inner layer 4 is also the innermost layer of the preform wall 2 or the preform 1.

The inner layer 4 preferably comprises a plastic, more preferably a polyolefin and in particular a polypropylene. The polyolefin of the inner layer 4 is preferably a regenerate.

The outer layer 5 may comprise a plastic, preferably a thermoplastic elastomer and, more preferably, an olefin-based thermoplastic elastomer and/or an olefin-containing thermoplastic vulcanizate. According to one embodiment, the thermoplastic elastomer of the outer layer 5 is a thermoplastic elastomer of the Santoprene brand or a polypropylene-EPDM mixture.

According to another variant of the first embodiment, the outer layer 5 comprises polyethylene, in particular HDPE. According to a further variant of the first embodiment, the outer layer 5 comprises polypropylene, in particular impact-modified polypropylene.

It is highly preferred that the preform 1 is produced by coextrusion. Both the olefin-based thermoplastic elastomer and the olefin-containing thermoplastic vulcanizate comprise an olefin or polyolefin, so that the outer layer 5 adheres well to the inner layer 4. This results in a material-locking, well-adhering composite of the inner layer 4 and the outer layer 5. This is all the more true since, in coextrusion, both plastics are brought into contact with each other in a molten state.

The preform 1 of the first embodiment is placed in a blow mold after coextrusion and after being cut to size. It is useful to close one end of the preform 1, which can be done in various ways. The preform 1 is then subjected to gas pressure, in particular air pressure, in the cavity 3 of the blow mold not shown here, so that the preform 1 conforms to an inner side of the blow mold and takes on its shape as a blow-molded structure. The blow-molded structure can be, for example, a tank, a tube with a variable cross-section in the axial direction, or a distribution tube. The distribution tube can have a plurality of outlets, for example.

The blow-molded structure comprises a structural wall which is formed from the preform wall during the blow molding process. The structural wall, which is not shown here for reasons of clarity, comprises in this embodiment an inner layer and an outer layer, the inner layer of the structural wall having been formed in a practical manner from the inner layer of the preform wall 2. Preferably, the outer layer of the structural wall is formed from the outer layer of the preform wall 2. Due to the good adhesion between the inner layer 4 and the outer layer 5 of the preform 1, the adhesive bond between these two layers 4, 5 remained intact during blow molding, thus preventing delamination.

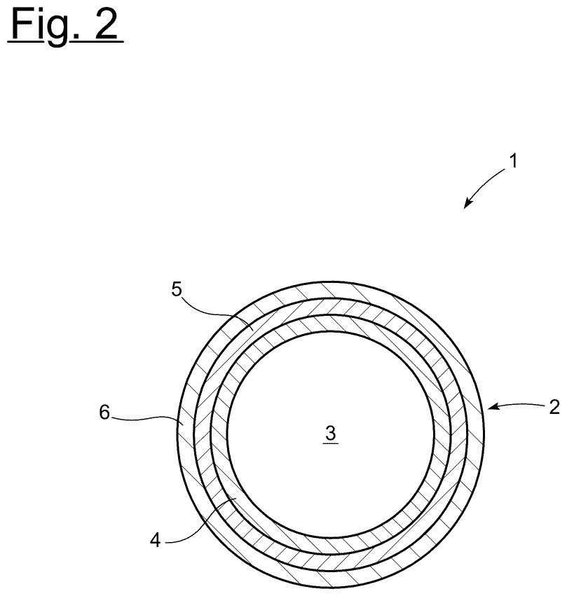

FIG. 2 shows a second embodiment of a preform 1 according to the present disclosure. It is possible that the preform 1 or the preform wall 2 comprises an exterior layer 6 in addition to the layers 4, 5. The exterior layer 6 can enclose the outer layer 5. It is possible that the exterior layer 6 rests against the outer layer 5. Advantageously, the inner layer 4 is the innermost layer. Preferably, the outer layer 5 is the outermost layer.

The inner layer 4 of the second embodiment preferably comprises a polyolefin, more preferably a polypropylene and particularly preferably a virgin polypropylene. According to a first variant of the second embodiment, the outer layer 5 preferably comprises a polyolefin, more preferably a polypropylene and particularly preferably a polypropylene regenerate. The outer layer 5 may comprise glass fibers for reinforcement, for example.

Advantageously, the exterior layer 6 of the second embodiment of the first variant comprises a plastic, more preferably a polyolefin and in particular a polyethylene, preferably an HDPE. Alternatively, the exterior layer 6 may comprise a thermoplastic elastomer and more preferably an olefin-based thermoplastic elastomer and/or an olefin-containing thermoplastic vulcanizate. According to a further alternative, the exterior layer 6 predominantly comprises a polypropylene.

In a second variant of the second embodiment, the outer layer 5 comprises a bonding agent and the exterior layer 6 comprises a preferably aliphatic polyamide, for example PA11 or PA12.

The preform 1 of the second embodiment can be subjected to blow molding in the same or a similar manner as the preform 1 from FIG. 1.

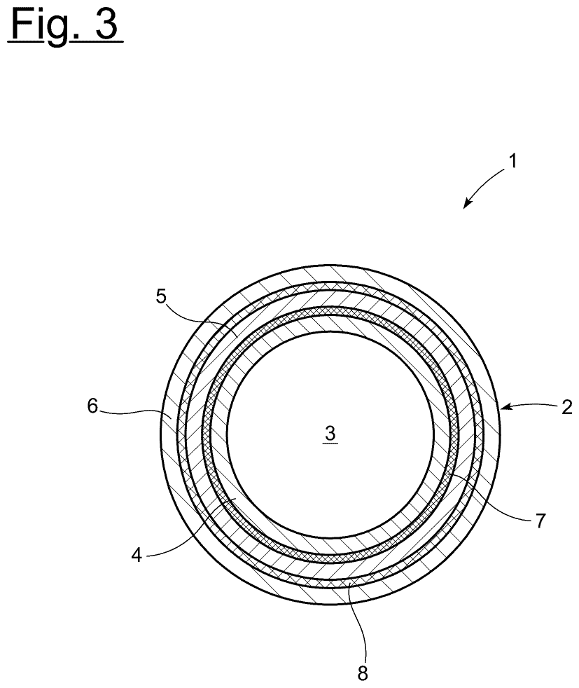

FIG. 3 shows a third embodiment of a preform 1 according to the present disclosure. Compared to the second embodiment, the preform 1 of the third embodiment additionally comprises an adhesive layer 7 and/or an adhesion layer 8.

It is preferred that the adhesive layer 7 is arranged between the inner layer 4 and the outer layer 5. Advantageously, the adhesive layer 7 adheres to the inner layer 4 and/or to the outer layer 5. The adhesive layer 7 preferably comprises a material which adheres better to the inner layer 4 and/or to the outer layer 5 than the outer layer 5 adheres to the inner layer 4. The adhesive layer 7 preferably comprises a plastic, and in particular a polyolefin. It is particularly preferred that the adhesive layer 7 comprises an adhesion promoter. The adhesion promoter of the adhesive layer 7 can be, for example, maleic anhydride. The proportion of maleic anhydride can be, for example, 3% by weight of the adhesive layer 7. It is preferred that the adhesive layer 7 has a layer thickness which is less than a layer thickness of the inner layer 4, the outer layer 5 and/or the exterior layer 6.

It is preferred that the adhesion layer 8 is arranged between the outer layer 5 and the exterior layer 6. The adhesion layer 8 advantageously adheres to the outer layer 5 and/or to the exterior layer 6. Preferably, the adhesion layer 8 comprises a material which adheres better to the outer layer 5 and/or to the exterior layer 6 than the outer layer 5 adheres to the exterior layer 6. The adhesion layer 8 preferably comprises a plastic, and in particular a polyolefin. It is particularly preferred that the adhesion layer 8 comprises an adhesion promoter. The adhesion promoter of the adhesion layer 8 can be, for example, maleic anhydride. The proportion of maleic anhydride may, for example, be 3% by weight of the adhesion layer 8. It is preferred that the adhesion layer 8 has a layer thickness which is less than a layer thickness of the inner layer 4, the outer layer 5 and/or the exterior layer 6.

### LIST OF REFERENCE SIGNS

1 Preform
2 Preform wall
3 Cavity of 1
4 Inner layer of 1, 2
5 Outer layer of 1, 2
6 exterior layer of 1, 2
7 Adhesive layer of 1, 2
8 Adhesion layer of 1, 2

1. A method for producing blow-molded structures, wherein a preform is provided, wherein the preform encloses a cavity and has a preform wall defining the cavity, wherein the preform is introduced into a blow mold and formed to a blow-molded structure, the blow-molded structure having a structural wall, and wherein the preform wall or the structural wall comprises an inner layer and an outer layer.

2. The method according to claim 1, wherein the structural wall is formed from the preform wall, wherein preferably the inner layer of the structural wall is formed from the inner layer of the preform wall and/or the outer layer of the structural wall is formed from the outer layer of the preform wall.

3. The method according to claim 1, wherein the inner layer of the preform wall or the structural wall comprises a polypropylene.

4. The method according to claim 1, wherein the preform wall or structural wall comprises at least 30 to 50 wt. % of a polyolefin.

5. The method according to claim 1, wherein the preform wall or structure wall comprises only two layers.

6. The method according to claim 1, wherein the blow-molded structure or preform has an exterior layer, wherein the exterior layer surrounds the outer layer.

7. The method according to claim 1, wherein the preform is a coextruded tube.

8. The method according to claim 1, wherein the blow-molded structure comprises at least three outlets.

9. A blow-molded structure, wherein the blow-molded structure is produced by the method according to claim 1.

10. Use of a blow-molded structure produced according to claim 1 for guiding a temperature control medium, wherein the temperature control medium comprises water or an oil.
